(19) United States
(12) Patent Application Publication
(10) Pub. No.: US 2010/0185319 A1
(43) Pub. Date: Jul. 22, 2010

(54) Device and Method for Separating Bulk Material

(75) Inventors: Guenther Petzold, Rellingen (DE); Hartmut Harbeck, Wedel (DE); Gerd Reischmann, Tornesch (DE)

Correspondence Address: LARSON AND LARSON, 11199 69TH STREET NORTH, LARGO, FL, 33773, US

(73) Assignee: TITECH GMBH, WEDEL (DE)

(21) Appl. No.: 12/732,834

(22) Filed: Mar. 26, 2010

Related U.S. Application Data
(63) Continuation-in-part of application No. 11/561,224, filed on Nov. 17, 2006.

(30) Foreign Application Priority Data
Jan. 12, 2004 (DE) 10 2004 001 790.5
Nov. 25, 2004 (DE) PCT/DE2004/002615

(51) Int. Cl. B07C 5/34; G06F 7/00

(52) U.S. Cl. 700/223

(57) ABSTRACT

The invention relates to a device and method for separating bulk materials with the aid of a blow-out device provided with blow-out nozzles arranged on a fall section which is disposed downstream from a conveyor belt. The blow-out nozzles are controllable by computer-controlled evaluation means according to sensor results of radiation, which penetrates the flow of bulk material on the conveyor belt, and emitted from an x-ray source and captured in the sensor means. The x-ray radiation, which passes through the particles of the bulk material, is filtered into at least two spectra of differing energy ranges before the radiation is captured by local resolution with the aid of at least one sensor means integrated within an energy range.

### CROSS-REFERENCE TO RELATED APPLICATION

This application is a continuation in part of U.S. patent application Ser. No. 11/561,224, titled “Device and Method for Separating Bulk Material,” attorney docket 195.70. This application bases priority on international application S.N. PCT/DE2004/002615, filed on Nov. 25, 2004, which in turn bases priority on German application S.N. 10 2004 001 790.5, filed on Jan. 12, 2004.

### FIELD

The invention relates to a device and a method for separating or sorting bulk materials according to the preamble of the main claim.

### BACKGROUND

Devices for separating bulk materials require a large number of sensors, particularly optical and electromagnetic sensors, such as is described in the applicant's EP B1-1 253 981.

Besides such sensors it is also advantageous to use X-radiation for the non-destructive testing of material characteristics of all possible objects, which are not readily detectable on the surface.

In this connection, U.S. Pat. No. 6,122,343 only provides the information given in the introductory part of claim 1, and only the reference that superimposed arrays can be used as sensor means indicate the possible appearance of the filters on the detectors. No further details are given of data processing and, instead, merely an increased contrast image constitutes the sought result.

Particularly, through the observation of a high resolution image while observing two X-radiation energy levels and the mathematical evaluation of a resulting differential image, makes it possible to obtain information on the constituents of individual bulk material particles, but no teaching in this direction is provided by U.S. Pat. No. 6,122,343.

This is, for instance, of interest when separating ores, where the decision as to whether a particle is or is not discarded decisively depends on whether and possibly which material is present in a specific bulk material particle. The method is also used in the separation of waste particles.

In known devices where X-ray sources were used, as a result of the not inconsiderable spatial dimensions of the X-ray sources and also the detectors, as well as the necessary screening or shielding, spatial demands have arisen making it impossible or only possible with considerable difficulty to bring about a place-precise evaluation, such as is required for the control of blow-out nozzles for blowing out smaller bulk material particles.

Prior techniques used multiple sources of X-ray radiation, for example, US Patent Publication 2004/0066890 to Dalmijn. Because X-ray sources are often vacuum tubes, such tubes are often relatively large, for example two inches in diameter. Because of the sizes, it is difficult to align the multiple sources of X-ray radiation, creating a skewing between the two or more sources of radiation. This skew is less significant for large materials on the conveyor belt such as batteries, shredded cars, etc., but is very significant for smaller particles such as small pieces of glass or any other bulk material such as small metal particles shredded from household waste. The extra X-ray source(s) add additional costs and reduces overall reliability of the system.

One problem is to provide a safe-saving arrangement with which it is not only reliably possible to detect small metal parts such as screws and nuts, but permitting the reliable separation thereof from the remaining bulk material flow through blow-out nozzles directly following the observation location.

### SUMMARY OF THE INVENTION

According to the invention, this problem is solved by the features of the main claim and, using one X-ray source and two or more X-ray filters for different energy levels which are, in each case, brought in front of the sensors, different information concerning the bulk material particles is obtained. Alternatively, the filters directly follow the X-ray source, or use X-ray sources with different emitted energies.

In some embodiments, the spatial arrangement of the filters are fixed so that moving of the bulk material particles brings about a suitable filter-following reflection of the x-radiation, e.g., by crystals onto a detector line or row, in the case, of an association of two measured results recorded at different times for the bulk material particles advancing on the bulk material conveyor belt.

In another embodiment of the device, two sensors are present, which follow one another transversely to the conveyor belt extension and are, e.g., located below the same. Through suitable mathematical delay loops, the successively obtained image information is associated with individual bulk material particles and, following mathematical evaluation, the same is used for controlling the blow-out nozzles.

Through the upstream placing of filters, the X-radiation is restricted to a specific energy level with respect to an X-ray source emitting in a broader spectrum prior to the same striking the bulk material particle. No further filter is then required between the bulk material particles and a downstream sensor.

In some embodiments, the device is equipped with a shield which is provided around the X-ray source, the irradiation location of the bulk material particles and the actual sensors in a X-ray-tight manner, but which also extends on the bulk material conveyor belt surface up to a filling device filling the conveyor belt via a sloping chute. This reduces X-ray emissions to operating personnel around the sorting and separating device. Covers are secured in such a way that upon removal of the covers, the device is disabled and cannot be operated.

The method for separating bulk materials with the aid of a blow-out device operates with blow-out nozzles located on a fall section downstream of a conveyor belt, the blow-out nozzles being controlled by a computer-assisted evaluating means as a function of the sensor results of radiation penetrating the bulk material flow on the conveyor belt, which is emitted by an X-ray source and is captured in sensor means.

Filtering of the X-radiation, which has traversed bulk material particles, takes place in at least two different spectra for the place-resolved capturing of the X-radiation, which has traversed the bulk material particles integrated in at least one line sensor over a predetermined energy range. This take place, for example, when using a sensor means (a long line formed from numerous individual detectors) by passing through different filters and successive capturing of the transmitted radiation or, preferably, by two sensor lines with, in each case, a different filter, the filters permitting the passage of different spectra, which on the one hand tend to have a soft and on the other a hard character.

A Z-classification and standardization of image areas takes place for determining the atomic density class on the basis of the sensor signals of the X-ray photons of different energy spectra captured in the at least two sensor lines.

Finally, the objectives are achieved by a segmentation of the characteristic class formation for controlling the blow-out nozzles on the basis of both the detected average transmission of the bulk material particles in the different X-ray energy spectra captured by the at least two sensor lines, and also the density information obtained by Z-standardization.

### BRIEF DESCRIPTION OF THE DRAWINGS

The detailed description of the invention, contained herein below, may be better understood when accompanied by a brief description of the drawings, wherein:

FIG. 1 illustrates a cut-away side view of FIG. 2 of the device for separating bulk materials;

FIG. 2 illustrates a perspective view of the device of the present invention, shown with removed radiation protection above the conveyor belt;

FIG. 3 illustrates a diagrammatic view of the method of the X-ray sensor means structure;

FIG. 3A illustrates a diagrammatic view of the two-channel sensor means of FIG. 3;

FIG. 4 illustrates a diagrammatic view of the method of the X-ray signal processing structure.

FIG. 5 illustrates a cross-sectional diagrammatic front view of the X-ray and sensors.

FIG. 6 illustrates a cross-sectional diagrammatic side view of the X-ray and sensors.

### DETAILED DESCRIPTION

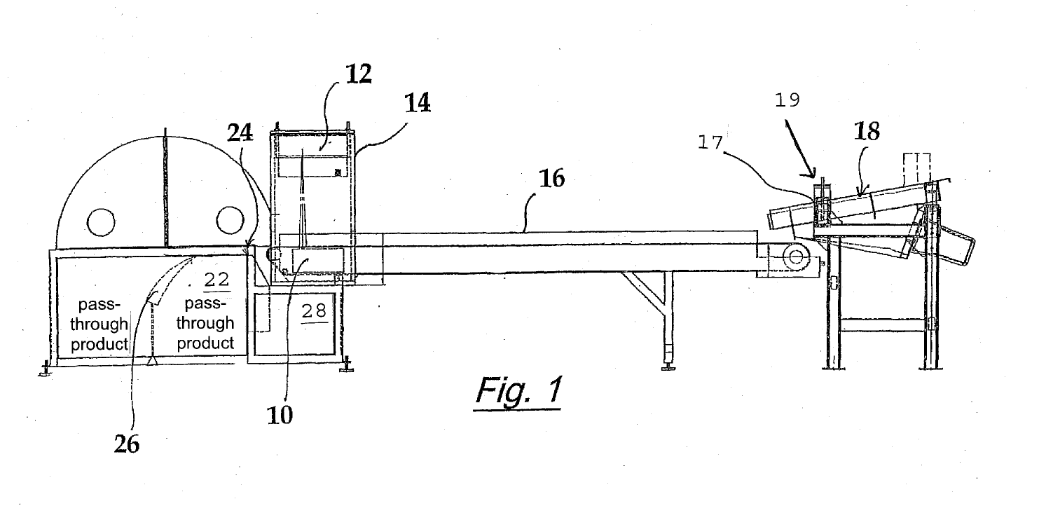

FIG. 1 shows a flat detector 10 positioned below a conveyor belt 20 and an X-ray source 12 positioned above a conveyor belt 20, which by means of downstream blow-out nozzles 24 located in two different product chambers, it is possible to separate a rejection product from a pass-through product in the bulk material flow. In some embodiments, a wedge-like separating element 26 between the two product flows has its slope adjusted so that it is easily possible to adapt to products of different heaviness with different flight characteristics without the blow-out air pressure having to be subsequently adjusted.

FIG. 1 also shows how, above the conveyor belt 20, there is a cover 16 for preventing X-radiation reflected against the product delivery direction passing out to the separating device. On the filling side there is a seal 17 of the conveyor belt box 19 through a sloping material delivery chute 18 on conveyor belt 20, so that minimal radiation passes out counter to the conveying direction parallel to the conveyor belt.

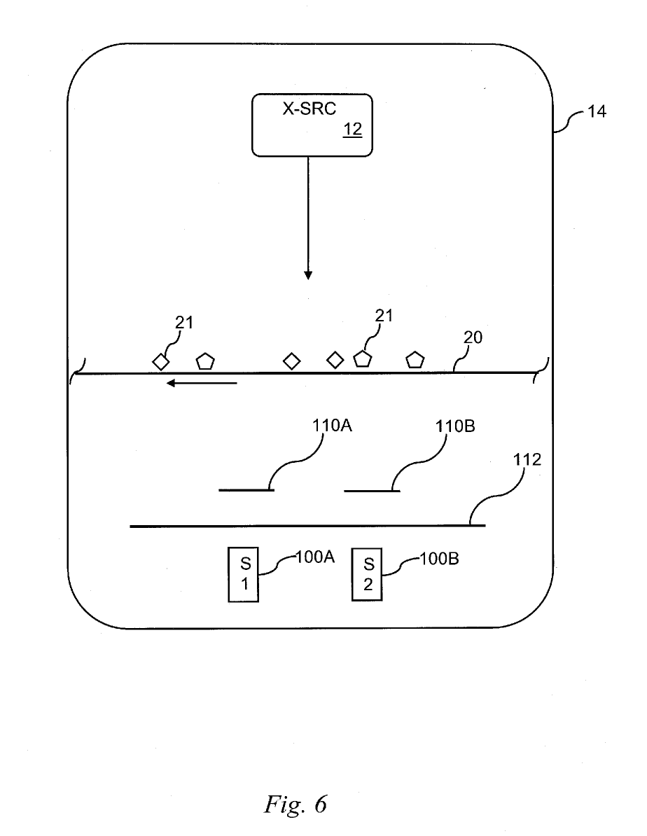

The device for separating bulk materials with the aid of a blow-out device with blow-out nozzles 24 located on a fall section downstream of a conveyor belt 20 consequently largely comprises computer-assisted evaluating algorithms which are controlled as a function of sensor results of two captured X-ray transmitted light images penetrating the bulk material flow on the conveyor belt 20, emitted by an X-ray source 12 and captured in sensor means 10. There are also two filter devices (see FIGS. 6 and 7) for passing on X-radiation in relation to mutually different energies placed upstream of the at least one sensor 10. The sensor having a plurality of individual pixels or sensor elements positioned transversely to the conveyor belt 20. For example, there is one sensor line for each filter.

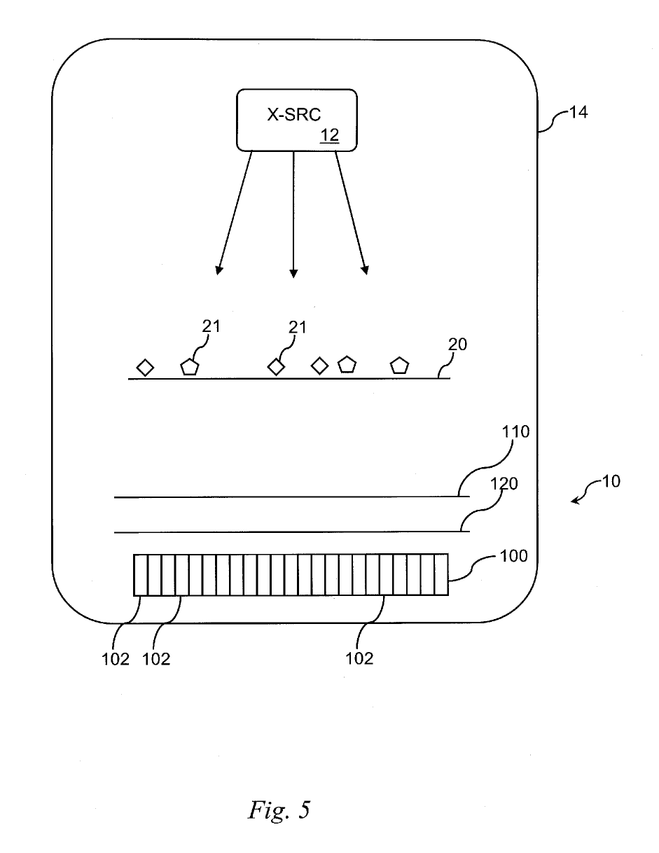

A sensor line (See FIGS. 5 and 6) corresponding to the conveyor belt width is formed by lined up photodiode arrays, whose active surface is covered with a fluorescent paper. The filters are preferably metal foils through which X-radiation of different energy levels is transmitted. However, the filters can also be formed by crystals, which reflect X-Ray radiation to mutually differing energy levels, particularly X-Ray radiation in different energy ranges in different solid angles.

In some embodiments, there are more than two filters for the use of more than two energy levels. Advantageously, the filters are located below the conveyor belt 20 upstream of the sensor means 10, and above the conveyor belt 20 is located an X-ray tube 12 producing a brems spectrum.

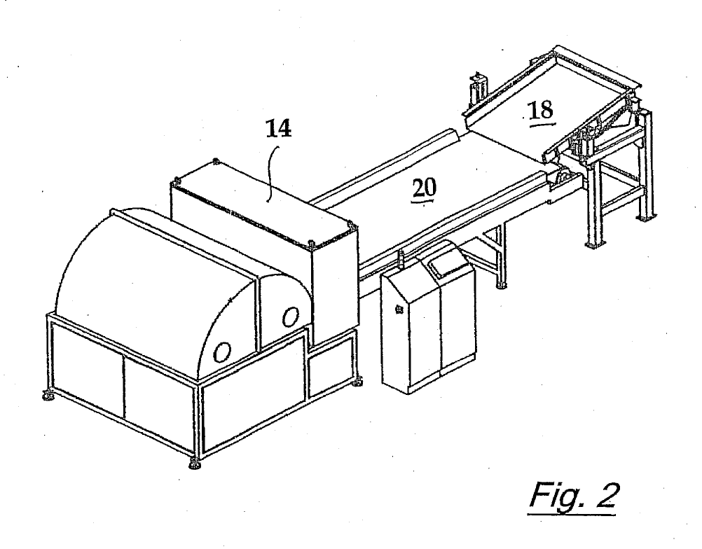

The device is equipped with a shielding box 14, above the conveyor belt 20, and surrounds the conveyor belt and the blow-out section 22, whereby a cover 16 covers the conveyor belt 20 in a section upstream of the X-ray source 12, and at the beginning of the belt there is a sloping chute 18 covering the entrance cross-section (shown respectively in FIG. 2). In the device shown inter alias, glass ceramic is separated from bottle glass. This enables the different glass types, as used in display screen tubes which in part have much higher melting points than “normal glass” and constitute a material difficult to separate in the recycling of broken glass, to be separated using the device.

For the better understanding of the separating procedure, a technical description will now be given of X-ray signal processing by means of two X-ray transmission spectra and segmentation into characteristic classes as shown in FIGS. 5 and 6. FIG. 5 shows a cross section with the conveyor belt 20 from the front having random objects 21 (e.g., particles such as granular glass). In FIG. 5, the individual sensor elements or pixels 102 of the sensor lines 100 are shown. FIG. 6 shows a cross section of the conveyor belt 20 from the side (the conveyor belt 20 passes from right to left), showing a side view of the sensor lines 100A/100B. In FIG. 6, the end sensor element 102 of each sensor line 100A/100B is visible. A suitable coverage is to be ensured within the framework of X-ray sensors, and this is achieved by a filter technique having spectral resolution. In this example, having two sensor lines 100A/100B, there are two filters 110A and 110B. Each of the filters 110A/110B passes different spectra of radiation, thereby allowing different spectra of radiation from the x-ray source 12, through the particles 21 of bulk material, through the conveyor belt and to the corresponding sensor line 100A/100B. Therefore, each sensor line 100A/100B receives and senses different spectra of radiation.

Through a suitable filtering of the X-radiation upstream of the particular sensor of the two-channel system, there is firstly a spectral selectivity. The arrangement of the sensor lines 100 then permits an independent filtering so that the optimum selectivity for a given separating function is achieved.

Generally, a higher energy spectrum and a lower energy spectrum are covered. For the higher energy spectrum, a high pass filter 110A is used which greatly attenuates the lower frequencies with lower energy content. The high frequencies are transmitted with limited attenuation. For this purpose, it is possible to use a metal foil of a metal with a higher density class 110A, such as a 0.45 mm thick copper foil. The higher density filter 110A is positioned between the XRAY source 12 and the higher frequency sensor line 100A. For the lower energy spectrum, the lower density filter 110B is used upstream of the given sensor line 100B as an absorption filter which suppresses a specific higher energy wave range. It is designed in such a way that the absorption is in close proximity to the higher density elements. For this purpose, it is possible to use a metal foil of a lower density class metal 110B, such as a 0.45 mm thick aluminum foil.

Each of the two sensor lines S1.i 100A and S2.i 100B comprises, for example, a plurality of photodiodes 102 (e.g., two sensor lines 100A/100B each comprising a linear row of 64 photodiodes). A scintillator 120 converts X-radiation into visible light (for example, florescent paper).

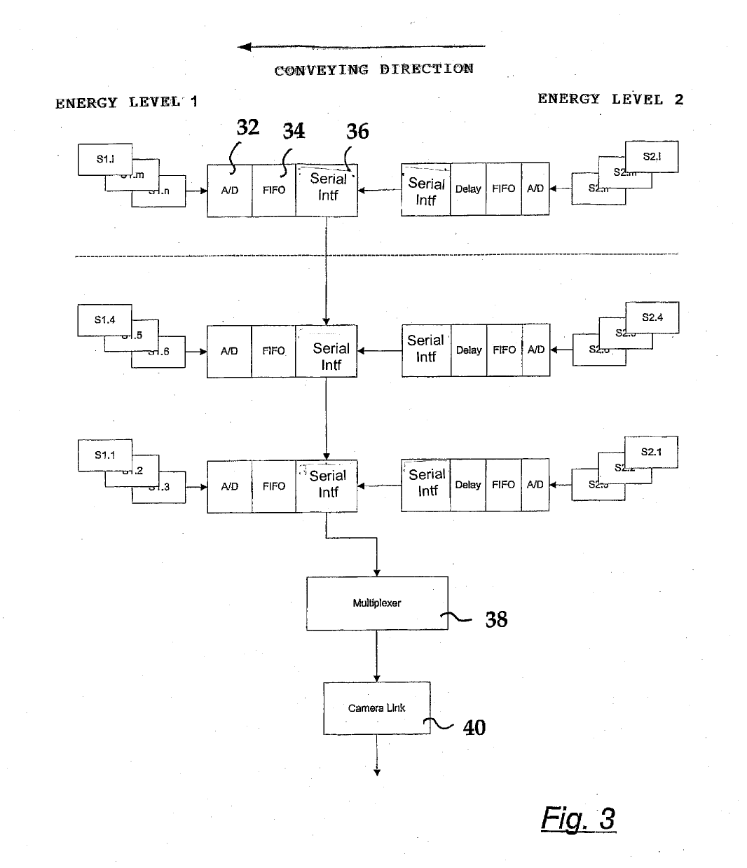

A typical array has 64 pixels 102 (in one row) with either 0.4 or 0.8 mm pixel raster. As diagrammatically shown in FIG. 3, by means of analog amplifiers and analog/digital converters 32, the intensity is digitized with, for example, 14 bit dynamics and read out in line-synchronous manner using FIFO (First In/First Out) memories 34 and a serial interface 36. The line first cut from the sorting product, as a result of the material conveying direction, is delayed until the data are quasi-simultaneously available with those of the subsequently cut line (with the other energy spectrum). The thus time-correlated data are converted by multiplexer 38 into a byte-serial data stream and transmitted via the standard interface Camera Link 40 over a distance of several meters to the evaluation electronics.

By lining up electronic modules, which in each case cover a 300 mm conveying width, it is possible to build up in two-channel form maximum conveying widths of 1800 mm. For this purpose, on each module the necessary operating voltages are generated anew and the clock signals are prepared anew.

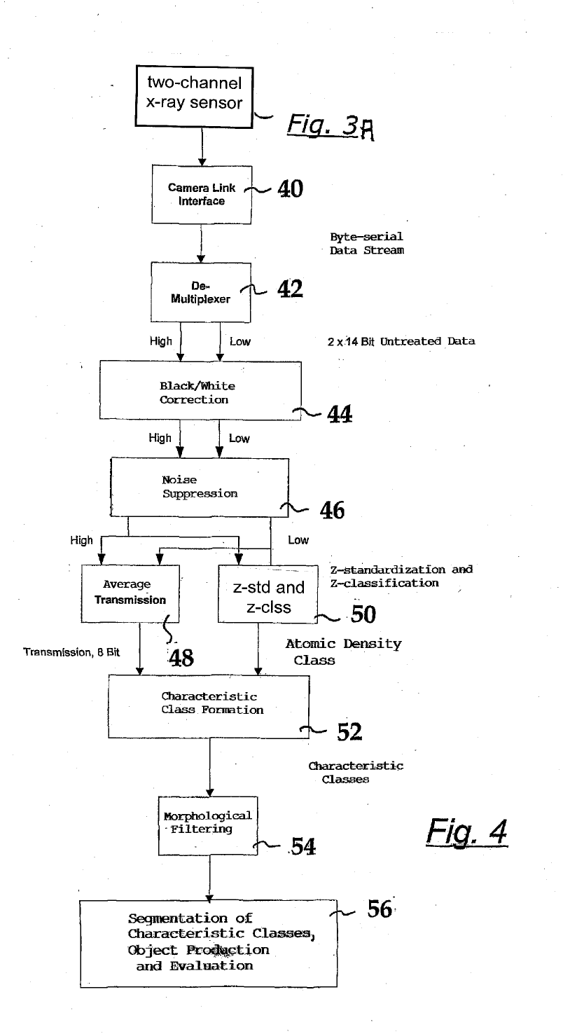

The X-ray signal processing takes place on the data stream transmitted via Camera Link 40 (shown diagrammatically in FIG. 4) and undergoes separation into two sensor channels, again using de-multiplexer 42.

For each channel, separately a black/white correction is carried out in an electronic unit 44. On measuring this correction stage, for each pixel determination takes place of the black value in the absence of radiation and the white value for 100% radiation, and an adjustment or compensation table is used. In normal operation the untreated data are corrected with the aid of said table. For suppressing signal noise 46, separately and for each channel by the buffer storage of a number of following lines, temporarily an image is built up and is smoothed by a mean value filter whose size in rows and columns is adjustable. This significantly reduces noise.

Z-transformation 50 produces from the intensities of two channels of different spectral imaging n classes of average atomic density (abbreviated to Z), whose association is largely independent of the X-ray transmission and, therefore, the material thickness.

A standardization of the values to an average atomic density of one or more selected representative materials makes it possible to differently classify image areas on either side of the standard curve. A calibration, in which over the captured spectrum the context is produced in non-linear manner, enables the “fading out” of equipment effects.

The atomic density class generated during the standardization to a specific Z (atomic number of an element or, more generally, average atomic density of the material) forms the typical density of the participating materials. In parallel to this, a further channel is calculated providing the resulting average transmission over the entire spectrum 48.

By computer-assisted combination of the atomic density class with a transmission interval (Tmin-, Tmax) to the pixels, a characteristic class is allocated 52 which, follows morphological filter 54 and is used for material differentiation 56.

Here again in temporary manner, an image of a few lines height is built up in order to suppress interfering information with a bi-dimensional filter. It is, e.g., possible for undesired misinformation to be suppressed at the edge of particles by cut pixels.

The data stream of characteristic classes 52 is treated as image material. The “machine idling” characteristic class describes the state when the X-ray source is switched on without sorting material in the measurement section. All characteristic pixels diverging from machine idling are processed as foreground and combined by segmentation to line segments, and finally to surfaces. The characteristic distributions over these surfaces are described by object data sets. In addition, said data sets also contain information regarding the position, shape and size of the linked characteristic surfaces.

In the evaluation quantity relations of the characteristic pixels, as well as the shape and size per object, are compared with learned parameters per material. On this basis the object is associated with a specific material class.

Equivalent elements can be substituted for the ones set forth above such that they perform in substantially the same manner in substantially the same way for achieving substantially the same result.

It is believed that the system and method of the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A device for separating bulk materials comprising:
a conveyor belt transporting bulk materials from a first end of the conveyor belt to a distal end of the conveyor belt,
a single X-ray tube producing a brems spectrum, the X-ray tube positioned above the conveyor belt;
at least two sensor lines, each sensor line having a filter positioned between the each sensor line and the conveyor belt, the filters permitting a passage of X-radiation in relation to mutually different energy spectra, each sensor line having a plurality of individual sensor elements, the plurality of individual sensor elements positioned transversely to the conveyor belt,
a computer-controlled means for evaluating signals from the sensor elements; and
a blow-out device having blow-out nozzles located on a fall section downstream of a conveyor belt and downstream of one and only one X-ray source, the blow-out nozzles controlled by the computer-controlled means for evaluating as a function of the signals resulting from radiation penetrating a flow of said bulk material on said conveyor belt, said radiation being emitted by the X-ray source and captured in the sensor elements.

2. The device for separating bulk materials according to claim 1, wherein each sensor line corresponds to a width of said conveyor belt and the sensor elements are linearly disposed photodiodes.

3. The device for separating bulk materials according to claim 2, wherein a fluorescent paper is disposed between the x-ray source and the photodiode arrays.

4. The device for separating bulk materials according to claim 1, wherein the at least two filters are metal foils through which the X-radiation of mutually different energy levels is passed.

5. The device for separating bulk materials according to claim 1, wherein said device further comprises a shielding box positioned above said conveyor belt for surrounding said conveyor belt and a blow-out section and a covering covers the conveyor belt in a section upstream of the X-ray source, and a sloping chute covers an entrance cross-section at a start of said conveyor belt.

6. The device for separating bulk materials according to claim 1, wherein the at least two filters including a plurality of filters passing a plurality of different energy levels.

7. A method for separating bulk material, the steps of the method comprising:
moving bulk material along a conveyor belt;
at a first location along the conveyor belt, emitting x-ray radiation from a single x-ray source, the x-ray radiation passing through particles of the bulk material at the first location and the x-ray radiation passing through at least two filters, each of the at least two filters passing x-ray radiation of a different spectra;
measuring levels of the x-ray radiation after the x-ray radiation has passed through the at least two filters by sensor elements of at least two sensor lines, each sensor line receiving the x-ray radiation after the x-ray radiation passes through one of the at least two filters, the sensor lines positioned traverse to the conveyor belt;
evaluating the particles at the first location using the levels of the x-ray radiation from each sensor element; and
redirecting a subset of the particles at a location downstream of the first location, the redirecting being performed based upon the evaluating.

8. The method of claim 7, wherein the redirecting is performed by a blow-out device having blow-out nozzles located downstream of the conveyor belt, the blow-out nozzles redirecting a flow of the particles.

9. The method according to claim 7, the step of evaluating further comprising the step of:
classifying of image areas using a Z-classification and standardization of the image areas thereby determining an atomic density class on a basis of signals from the sensor elements corresponding to x-ray photons of different energy spectra captured by the sensor elements.

10. The method according to claim 7, the step of evaluating further comprising the step of:
segmenting of a characteristic class formation on a basis of both a detected average transmission of said particles in different X-ray energy spectra captured by the sensor elements, and a density information obtained by Z-standardization.

11. A device for separating bulk materials comprising:
a single means for emitting a brems spectrum of x-ray radiation,
a means for transporting particles of the bulk material, radiation from the single means for emitting radiates the particles and part of the radiation passes through at least two filters and the part of the radiation reaches a means for sensing,
a means for evaluating analyzes signals from the means for sensing and controls a means for sorting the particles, thereby sorting the particles according to the signals from the means for sensing.

12. The device for separating bulk materials according to claim 11, wherein the means for sorting is a blow-out device having blow-out nozzles, the blow-out device being located on downstream of the means for transporting and downstream of the means for emitting, the blow-out nozzles controlled by the means for evaluating as a function of the signals resulting from the radiation penetrating a flow of said particles on the means for transporting.

13. The device for separating bulk materials according to claim 11, wherein the means for sensing comprises at least two sensor lines, each sensor line having one of the filters positioned between the each sensor line and the means for transporting, the particles and the means for emitting, the filters permit a passage of X-radiation in relation to mutually different energy spectra, each sensor line having a plurality of individual sensor elements, the plurality of individual sensor elements positioned transversely to the means for transporting.

14. The device for separating bulk materials according to claim 11, wherein the means for transporting comprises a conveyor belt.

15. The device for separating bulk materials according to claim 14, wherein each sensor line corresponds to a width of said conveyor belt and the sensor elements are linearly disposed photodiodes.

16. The device for separating bulk materials according to claim 11, wherein the filters are metal foils through which radiation of mutually different energy levels is passed.

17. The device for separating bulk materials according to claim 11, wherein the at least two filters including a plurality of filters passing a plurality of different energy levels.

18. The device for separating bulk materials according to claim 11, wherein the means for evaluating uses a Z-classification and standardization of image areas thereby determining an atomic density class on a basis of signals from the means for sensing corresponding to x-ray photons of different energy spectra captured by the means for sensing.

19. The device for separating bulk materials according to claim 11, wherein the means for evaluating uses segmenting of a characteristic class formation on a basis of both a detected average transmission of said particles in different radiation energy spectra captured by the means for sensing, and a density information obtained by Z-standardization.
